(19) United States
(12) Patent Application Publication
(10) Pub. No.: US 2016/0071065 A1
(43) Pub. Date: Mar. 10, 2016

(54) INFORMATION PROCESSING DEVICE, NON-TRANSITORY COMPUTER READABLE MEDIUM, AND INFORMATION PROCESSING METHOD

(71) Applicant: FUJI XEROX CO., LTD., Tokyo (JP)

(72) Inventors: Jun OHASHI, Kanagawa (JP); Shinji KAWAMOTO, Kanagawa (JP)

(73) Assignee: FUJI XEROX CO., LTD., Tokyo (JP)

(21) Appl. No.: 14/607,130

(22) Filed: Jan. 28, 2015

(30) Foreign Application Priority Data
Sep. 8, 2014 (JP) 2014-182107

(51) Int. Cl. G06Q 10/10

(52) U.S. Cl. CPC G06Q 10/1095

(57) ABSTRACT

An information processing device includes an accepting unit that accepts a meeting material that is a material distributed to a participant of a meeting, information indicating the participant of the meeting, and a rule for manipulating the meeting material based on an attribute of the participant, an extracting unit that extracts the attribute of the participant, and a manipulating unit that manipulates the meeting material, by applying the attribute of the participant to the rule.

### CROSS-REFERENCE TO RELATED APPLICATIONS

This application is based on and claims priority under 35 USC 119 from Japanese Patent Application No. 2014-182107 filed Sep. 8, 2014.

### BACKGROUND

### Technical Field

The present invention relates to an information processing device, a non-transitory computer readable medium, and an information processing method.

### SUMMARY

According to an aspect of the invention, there is provided an information processing device including an accepting unit that accepts a meeting material that is a material distributed to a participant of a meeting, information indicating the participant of the meeting, and a rule for manipulating the meeting material based on an attribute of the participant, an extracting unit that extracts the attribute of the participant, and a manipulating unit that manipulates the meeting material, by applying the attribute of the participant to the rule.

### BRIEF DESCRIPTION OF THE DRAWINGS

Exemplary embodiments of the present invention will be described in detail based on the following figures, wherein:

FIG. 1 is a conceptual module diagram of an example of configuration according to a first exemplary embodiment;

FIG. 2 illustrates an example of system configuration in a case where the first exemplary embodiment is implemented;

FIG. 3 illustrates an example of the data structure of a material information table;

FIG. 4 illustrates an example of the data structure of a personal information table;

FIG. 5 illustrates an example of processing according to the first exemplary embodiment;

FIG. 6 illustrates an example of the data structure of a manipulation method table;

FIGS. 7A to 7E each illustrate an example of the data structure of a target person's attribute table;

FIG. 8 is a flowchart illustrating an example of processing according to the first exemplary embodiment;

FIG. 9 is a flowchart illustrating an example of processing according to the first exemplary embodiment;

FIGS. 10A to 10F each illustrate an example of processing according to the first exemplary embodiment;

FIGS. 11A to 11C each illustrate an example of processing according to the first exemplary embodiment;

FIG. 12 is a conceptual module diagram of an example of configuration according to a second exemplary embodiment;

FIG. 13 illustrates an example of system configuration in a case where the second exemplary embodiment is implemented;

FIG. 14 illustrates an example of the data structure of a personal information table;

FIG. 15 illustrates an example of the data structure of an importance table;

FIG. 16 is a flowchart illustrating an example of processing according to the second exemplary embodiment;

FIG. 17 illustrates an example of the data structure of an importance/preparation time correspondence table;

FIGS. 18A to 18F each illustrate an example of processing according to the second exemplary embodiment;

FIGS. 19A to 19C each illustrate an example of processing according to the second exemplary embodiment;

FIG. 20 is a conceptual module diagram of an example of configuration according to a third exemplary embodiment;

FIGS. 21A and 21B each illustrate an example of processing according to the third exemplary embodiment; and

FIG. 22 is a block diagram illustrating an example of the hardware configuration of a computer that implements the exemplary embodiments.

### DETAILED DESCRIPTION

Hereinafter, various exemplary embodiments of the invention will be described with reference to the drawings.

### First Exemplary Embodiment

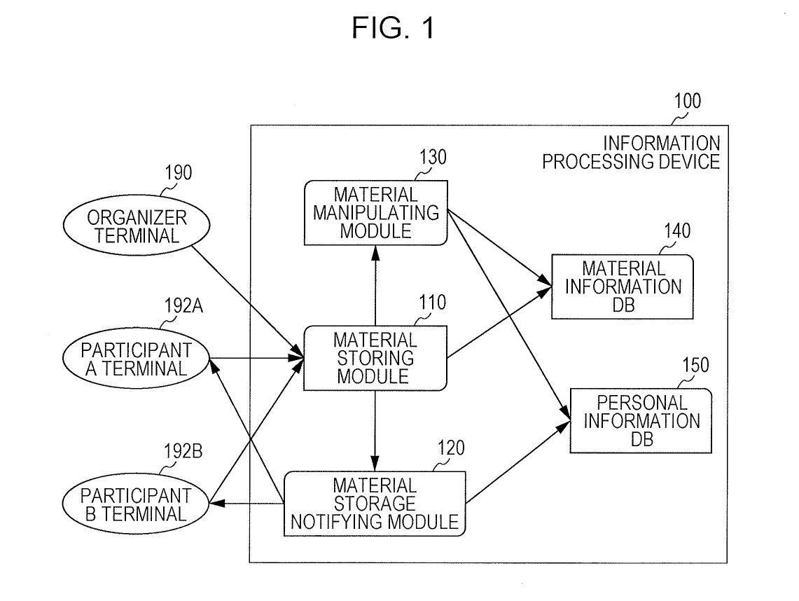

FIG. 1 is a conceptual module diagram of an example of configuration according to a first exemplary embodiment.

The term “module” generally refers to a logically separable component of software (computer program), hardware, or the like. Therefore, the term “module” as used in the exemplary embodiments refers to not only a module in a computer program but also a module in a hardware configuration. Thus, the exemplary embodiments will be also described in the context of a computer program for providing functions of modules (a program for causing a computer to execute individual procedures, a program for causing a computer to function as individual units, and a program for causing a computer to realize individual functions), a system, and a method. While “store”, “be stored”, and equivalent expressions are used herein for the convenience of description, these expressions mean, when an exemplary embodiment relates to a computer program, “cause a memory to store” or “perform control so as to cause a memory to store.” While individual modules and functions may have a one-to-one correspondence, in actual implementation, a single module may be implemented by a single program, or multiple modules may be implemented by a single program. Conversely, a single module may be implemented by multiple programs. Further, multiple modules may be executed by a single computer, or a single module may be executed by multiple computers that are in a distributed or parallel environment. A single module may include another module. In the following description, the term “connection” refers to not only a physical connection but also a logical connection (such as exchanging of data, issuing of an instruction, and cross-reference between data items). The term “predetermined” as used herein means being determined prior to a process of interest, which not only means being determined before processing according to the exemplary embodiments begins but also being determined, even after the processing according to the exemplary embodiments begins, at any point in time preceding a process of interest in accordance with the condition/state at that point in time, or in accordance with the condition/state up to that point in time. If multiple “predetermined values” exist, each of these values may be different, or two or more of these values may be the same (which includes, of course, cases where all of these values are the same). Further, expressions that have the meaning of “if A, then B” is used to mean that “it is determined whether A, and then B if it is determined that A”, unless it is not required to determine whether A.

Furthermore, the term “system” or “device” includes not only cases where a system or device is made up of multiple computers, hardware components, devices, or the like that are connected to each other via a communication medium such as a network (including a one-to-one communication setup), but also cases where a system or device is implemented by a single computer, hardware component, or device. The terms “device” and “system” are herein used synonymously. As a matter of course, the term “system” does not include what is merely a social “mechanism” (social system) which is a man-made arrangement of rules.

Further, for each process executed by each module or, if multiple processes are to be executed within a module, for each of the multiple processes, information of interest is read from a memory, and after execution of the corresponding process, the results of processing are written into the memory. Therefore, a description about reading of information from a memory prior to a process, or writing of information into a memory after a process will sometimes be omitted. The term “memory” as used herein may include a hard disk, a random access memory (RAM), an external storage medium, a memory using a communication line, and a register in a central processing unit (CPU).

An information processing device 100 according to the exemplary embodiments is used to manipulate a meeting material. As illustrated in FIG. 1, the information processing device 100 has a material storing module 110, a material storage notifying module 120, a material manipulating module 130, a material information DB 140, and a personal information DB 150.

To improve the efficiency of a meeting, it is generally common to distribute a material (to be also referred to as “meeting material” hereinafter) to the meeting attendees in advance to provide information on the upcoming meeting to ensure that the meeting will run smoothly. If there is not so much meeting material, it is possible for the meeting participants to peruse all of the meeting material. However, if, for example, there are multiple subjects to be discussed and there is a large amount of meeting material, the participants may want to peruse the material while focusing on those portions of the material which are directly related to their own job. However, situations may arise where it takes time to locate these portions, or the participants skip portions of the material which the meeting organizer wants the participants to read. That is, if a meeting material is distributed as it is, it may not be possible to identify which part of the material is relevant in a short time.

The material storing module 110 is connected to the material storage notifying module 120, the material manipulating module 130, the material information DB 140, a terminal used by a meeting organizer (to be referred to as “organizer terminal” hereinafter) 190, a terminal used by Meeting Participant A (to be referred to as “Participant A terminal” hereinafter) 192A, and a terminal used by Meeting Participant B (to be referred to as “Participant B terminal” hereinafter) 192B. The material storing module 110 accepts a meeting material, which is a material distributed to each of the participants of a meeting, information indicating the participants of the meeting, and a rule for manipulating the meeting material. The term “meeting” may refer to any meeting conducted with participation of multiple persons, and the term is used herein as a concept that also encompasses assemblies, gatherings, lectures, and the like. Further, the participants may not necessarily gather in a single location. That is, the term “meeting” also includes meetings conducted by using teleconferencing systems or the like. An electronic document means electronic data (also called file) including mostly text data but also, depending on the case, graphics, images, movies, or audio, or a combination thereof, and the term refers to data that is subject to storage, editing, retrieval, or the like and may be exchanged between systems or users as a discrete unit, or other similar data. Specifically, the term “electronic document” includes documents created by document creation programs, Web pages, and the like. The term “meeting material” refers to any material that may be used in the meeting of interest, and in this sense merely the possibility that the material will be used suffices. Accordingly, the term “meeting material” includes materials not actually used in the meeting in the end. Furthermore, the term “rule” refers to information (to be also referred to as “manipulation information” hereinafter) that specifies how a meeting material is to be manipulated and displayed based on what kind of person the participant is.

Specifically, the material storing module 110 has a mechanism that enables storage of “meeting ID (information (identification (ID) for uniquely identifying a meeting according to the exemplary embodiments)”, “meeting name”, “meeting material”, “manipulation information”, and “personal ID of meeting participant”, and allows users to view a material.

Specifically, the above pieces of information are input through operation of the organizer terminal 190 by the meeting organizer. The material storing module 110 further has a mechanism for writing the input information to the material information DB 140.

Further, the material storing module 110 has a mechanism for, when a meeting material is stored into the material information DB 140, inputting “personal ID of meeting participant” and “meeting ID” associated with the meeting material to the material storage notifying module 120.

Further, the material storing module 110 has a mechanism that allows each participant using a terminal used by a meeting participant (to be referred to as “participant terminal” hereinafter) 192 to view “meeting material” that has been manipulated.

Further, the material storing module 110 has a mechanism for inputting, to the material manipulating module 130, “personal ID of meeting participant” who has accessed “meeting material” by operation of a participant using the participant terminal 192. That is, the material storing module 110 stores a viewing history.

The material storage notifying module 120 is connected to the material storing module 110, the personal information DB 150, the Participant A terminal 192A, and the Participant B terminal 192B. The material storage notifying module 120 has a mechanism that makes it possible to notify a corresponding meeting participant of the fact that a material has been stored into the material storing module 110.

Specifically, in accordance with “personal ID of meeting participant”, the material storage notifying module 120 acquires “email address of participant” from the personal information DB 150, and notifies a corresponding meeting participant of the fact that a meeting material has been stored and also the storage location of the meeting material.

The material manipulating module 130 is connected to the material storing module 110, the material information DB 140, and the personal information DB 150. The material manipulating module 130 extracts experience as an example of an attribute of the meeting participant of interest. Then, the material manipulating module 130 manipulates a meeting material by applying the experience of the participant to a rule.

Specifically, the material manipulating module 130 has a mechanism for comparing “manipulation information” with “meeting participant's attributes (including what is generally referred to as role)”, and manipulating a material in accordance with the comparison results.

More specifically, the material manipulating module 130 has a mechanism for acquiring personal information stored in the personal information DB 150, from “personal ID” of a person who has accessed a meeting material.

Further, the material manipulating module 130 has a mechanism for acquiring manipulation information from the material information DB 140.

Further, the material manipulating module 130 has a mechanism for comparing “attribute specified by manipulation information” with “attributes assigned to a person who has accessed a meeting material”, and manipulating the material in a manner that conforms to the manipulation information.

Further, the material manipulating module 130 has a mechanism for displaying, to a participant who has accessed a meeting material, a meeting material that has been manipulated into a form that takes “personal experience” into consideration.

The material manipulating module 130 may perform a manipulation such as attaching “past meeting material” stored in the material information DB 140 to a meeting material so that a person without any knowledge related to a meeting may catch up prior to the meeting. This corresponds to a case where manipulation information includes “Attach past meeting material.”

A manipulation process by the material manipulating module 130 may be performed when a meeting material is stored (in which case a meeting material manipulated for each individual participant is stored), or when a meeting material is viewed (in which case a single original meeting material is stored).

The material information DB 140 is connected to the material storing module 110 and the material manipulating module 130. The material information DB 140 is a database for accumulating information stored by the material storing module 110.

The material information DB 140 may have the function of a database for saving the association between meetings and meeting materials. Further, the material information DB 140 also saves the association between meetings, and also allows referencing to a meeting material for a meeting related to the meeting of interest.

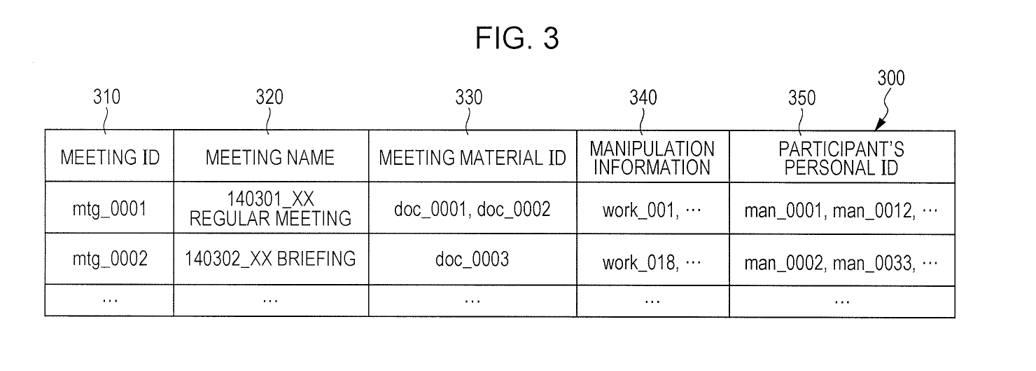

Specifically, the material information DB 140 stores, for example, a material information table 300. FIG. 3 illustrates an example of the data structure of the material information table 300. The material information table 300 has a meeting ID field 310, a meeting name field 320, a meeting material ID field 330, a manipulation information field 340, and a participant's personal ID field 350. The meeting ID field 310 stores information for uniquely identifying a meeting (meeting identification (ID)) according to the exemplary embodiments. The meeting name field 320 stores the name of the meeting. The meeting material ID field 330 stores information for uniquely identifying a meeting material used in the meeting (meeting material identification (ID)) according to the exemplary embodiments. Examples of such information may include document name, and Uniform Resource Identifier ((URI), including Uniform Resource Locator (URL)) that describes the location of the meeting material. The manipulation information field 340 stores manipulation information for the meeting material. The manipulation information field 340 may store, for example, the manipulation information itself or the name of a file in which the manipulation information is written. The participant's personal ID field 350 stores the personal ID of a participant of the meeting.

The personal information DB 150 is connected to the material storage notifying module 120 and the material manipulating module 130. The personal information DB 150 is a database that stores information such as the e-mail addresses of potential meeting participants or attributes of the potential participants.

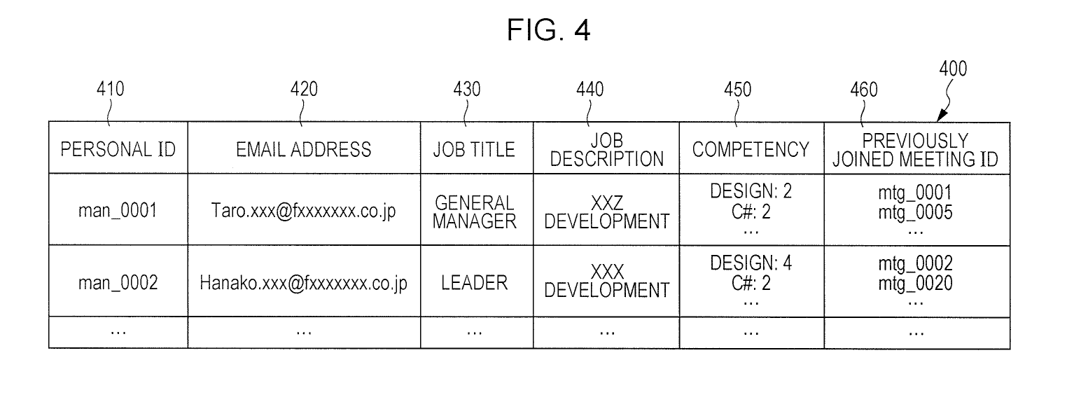

Specifically, the personal information DB 150 stores, for example, a personal information table 400. FIG. 4 illustrates an example of the data structure of the personal information table 400. The personal information table 400 has a personal ID field 410, an email address field 420, a job title field 430, a job description field 440, a competency field 450, and a previously joined meeting ID field 460. The personal ID field 410 stores information (personal ID) for uniquely identifying an individual person (participant) according to the exemplary embodiments. The email address field 420 stores the email address of the person. The job title field 430 stores information indicating the job title of the person. The job description field 440 stores a description of the job of the person. The competency field 450 stores information indicating the competency (qualifications or aptitude) of the person. The previously joined meeting ID field 460 stores the meeting ID of a meeting previously joined by the person. For example, as attributes of a participant, information stored in the job title field 430, the job description field 440, the competency field 450, and the previously joined meeting ID field 460 may be used. Thus, attributes of an individual person according to the exemplary embodiments include, in addition to what is referred to as role, information related to the skill or previous experience of the person.

The organizer terminal 190 is connected to the material storing module 110. The organizer terminal 190 is a terminal used by the meeting organizer, and issues an instruction to the information processing device 100.

The participant terminal 192 (the Participant A terminal 192A or the Participant B terminal 192B) is connected to the material storing module 110 and the material storage notifying module 120. The Participant A terminal 192A, which is a terminal used by Participant A of a meeting, accepts a notification from the information processing device 100, and issues an instruction to the information processing device 100. Of course, there may be three or more participant terminals 192, and also, there may be two or more organizer terminals 190.

Each of the organizer terminal 190 and the participant terminal 192 is, for example, a personal computer, and includes, for example, a display such as a liquid crystal display, a keyboard, a mouse, and a touch panel.

For example, the information processing device 100 is used as follows.

The meeting organizer operates the organizer terminal 190 to register “meeting material”, “meeting participant”, and “manipulation information.” Then, the material manipulating module 130 compares “experience of meeting participant” with “manipulation information”, and manipulates the material into “a form that makes it possible to easily view points to be checked which differ for each individual person.” This is to allow each meeting participant to check “parts that are relevant to the participant himself/herself” within the material in a short time.

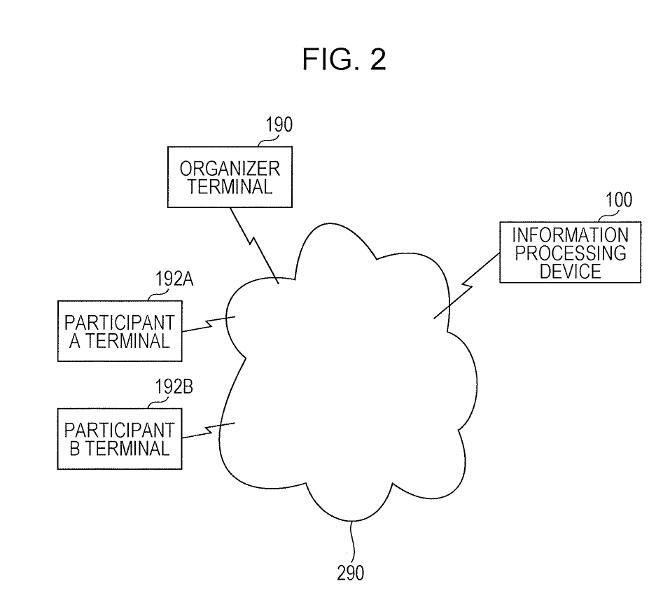

FIG. 2 illustrates an example of system configuration in a case where the first exemplary embodiment is implemented.

The information processing device 100, the organizer terminal 190, the Participant A terminal 192A, and the Participant B terminal 192B are connected to each other via a communication line 290. The communication line 290 may be a wired line, a wireless line, or a combination thereof. For example, the communication line 290 may be an intranet or the Internet as a communication infrastructure. The information processing device 100 accepts an instruction from the organizer terminal 190, and causes a meeting material manipulated for each individual participant to be viewed by the participant terminal 192.

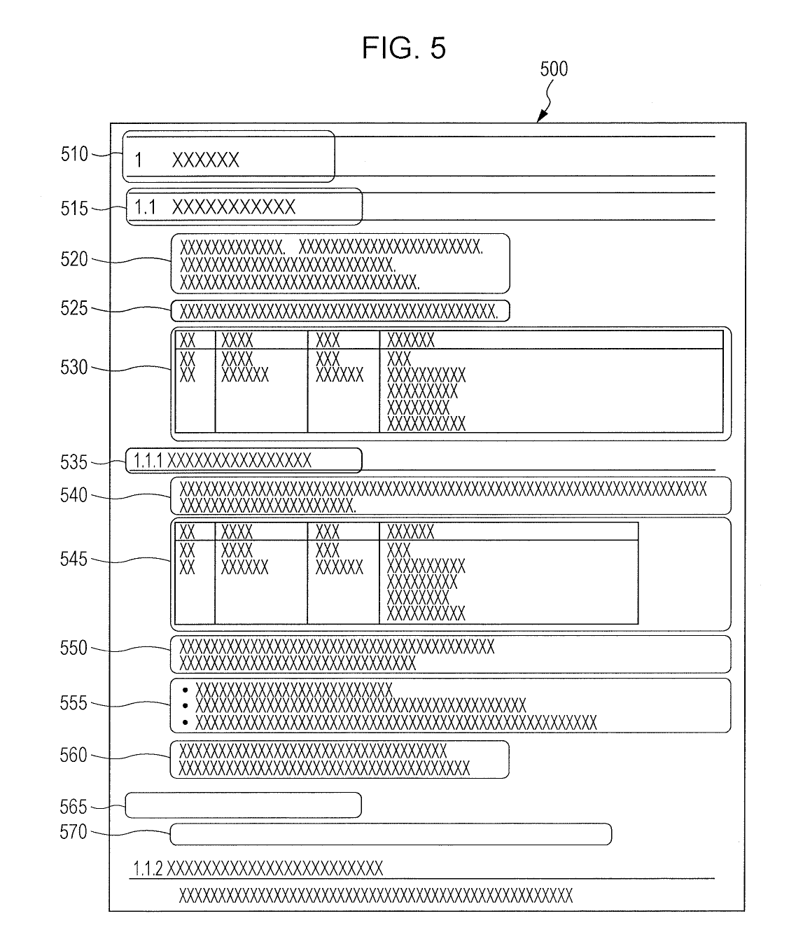

FIG. 5 illustrates an example of processing according to the first exemplary embodiment. Referring to FIG. 5, specific examples of objects to be manipulated (to be also referred to as “manipulation objects” hereinafter) will be described.

The term “manipulation information” refers to information for enabling a setting that causes a specified piece of content in a meeting material to be viewed in a different way (appear differently) when the meeting material is accessed by a meeting participant who is assigned (or not assigned) a predetermined attribute. Examples of the attribute include “Job title x or lower”, “Java competency: X or lower”, “Not join meeting x”, “Not in charge of job x”, and “In charge of job y.” Examples of manipulation include “enlarge”, “reduce”, “hide”, “frame”, and “disable print.” The term “content” refers to an area that may be specified within the contents of a meeting material. Examples of content include pages, titles, paragraphs, graphics, and tables. Each area bounded by a frame as illustrated in FIG. 5 corresponds to one piece of content. A document 500 has the following pieces of content: content 510, content 515, content 520, content 525, content 530, content 535, content 540, content 545, content 550, content 555, content 560, content 565, and content 570, which are manipulation objects. For example, the document 500 is displayed on the organizer terminal 190, and in accordance with operation of the organizer terminal 190 by the meeting organizer, a piece of content is selected from the document 500 to specify a manipulation object. Each piece of content may be extracted by using document analysis techniques or the like. For example, if a piece of content is a structured document such as HTML, the portion bounded by a tag may be extracted.

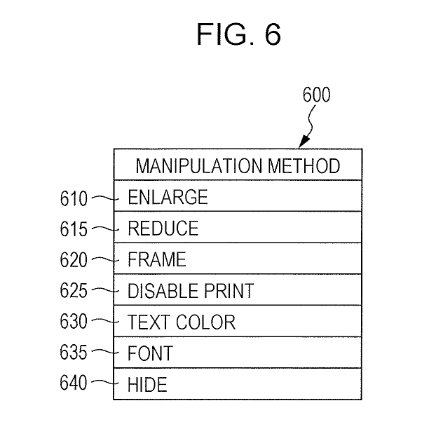

FIG. 6 illustrates an example of the data structure of a manipulation method table 600. The manipulation method table 600, which stores predetermined manipulation methods, has the following items: Enlarge 610, Reduce 615, Frame 620, Disable Print 625, Text Color 630, Font 635, Hide 640, and the like. For example, the manipulation method table 600 is displayed on the organizer terminal 190, and in accordance with operation of the organizer terminal 190 by the meeting organizer, an item is selected from the manipulation method table 600 to specify a manipulation method for a manipulation object.

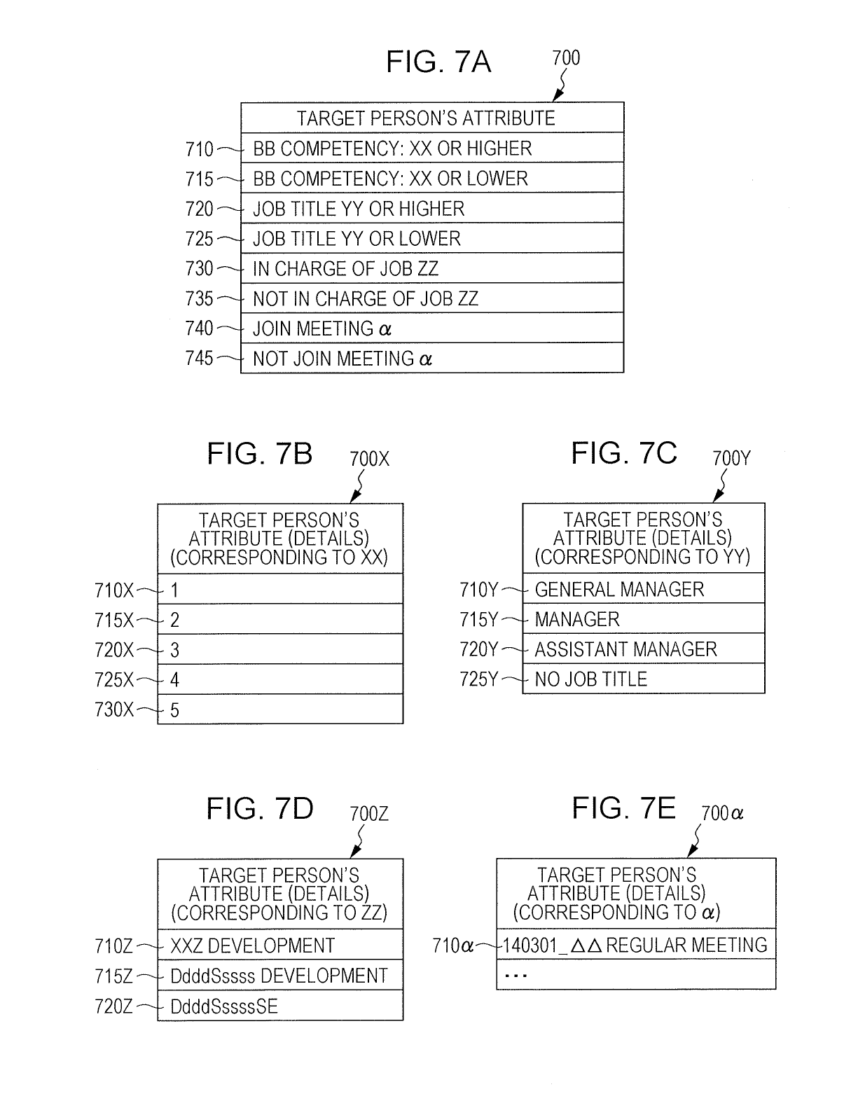

FIG. 7A illustrates an example of the data structure of an attribute table (to be referred to as “target person's attribute table” hereinafter) 700 for a person for whom a manipulation is to be performed (to be referred to as “target person” hereinafter). The target person's attribute table 700 has items such as “BB competency: XX or higher” 710, “BB competency: XX or lower” 715, “Job title YY or higher” 720, “Job title YY or lower” 725, “In charge of job ZZ” 730, “Not in charge of job ZZ” 735, “Join meeting α” 740, and “Not join meeting α” 745. In accordance with operation by the meeting organizer, an item is selected from the target person's attribute table 700α to specify the condition for performing a manipulation (condition using participant's attributes). The “XX” in each of the items “BB competency: XX or higher” 710 and “BB competency: XX or lower” 715 is selected from a target person's attribute (details) (corresponding to XX) table 700X. The “YY” in each of the items “Job title YY or higher” 720 and “Job title YY or lower” 725 is selected from a target person's attribute (details) (corresponding to YY) table 700Y. The “ZZ” in each of the items “In charge of job ZZ” 730 and “Not in charge of job ZZ” 735 is selected from a target person's attribute (details) (corresponding to ZZ) table 700Z. The “α” in each of the items “Join meeting α” 740 and “Not join meeting α” 745 is selected from a target person's attribute (details) (corresponding to α) table 700α.

FIG. 7B illustrates an example of the data structure of the target person's attribute (details) (corresponding to XX) table 700X. The target person's attribute (details) (corresponding to XX) table 700X has the following pieces of information: “1” 710X, “2” 715X, “3” 720X, “4” 725X, and “5” 730X.

FIG. 7C illustrates an example of the data structure of the target person's attribute (details) (corresponding to YY) table 700Y. The target person's attribute (details) (corresponding to YY) table 700Y has the following pieces of information: “General manager” 710Y, “Manager” 715Y, “Assistant manager” 720Y, and “No job title” 725Y.

FIG. 7D illustrates an example of the data structure of the target person's attribute (details) (corresponding to ZZ) table 700Z. The target person's attribute (details) (corresponding to ZZ) table 700Z has the following pieces of information: “XXZ development” 710Z, “DdddSssss development” 715Z, and “DdddSssssSE development” 720Z.

FIG. 7E illustrates an example of the data structure of the target person's attribute (details) (corresponding to α) table 700α. The target person's attribute (details) (corresponding to α) table 700α has “140301_ΔΔ regular meeting” 710α. For example, a meeting name stored in the material storing module 110 as a past history may be used.

For example, the target person's attribute (details) table 700 or the like is displayed on the organizer terminal 190, and in accordance with operation of the organizer terminal 190 by the meeting organizer, an attribute is selected from the target person's attribute (details) table 700 or the like to specify a condition with respect to participant's attributes.

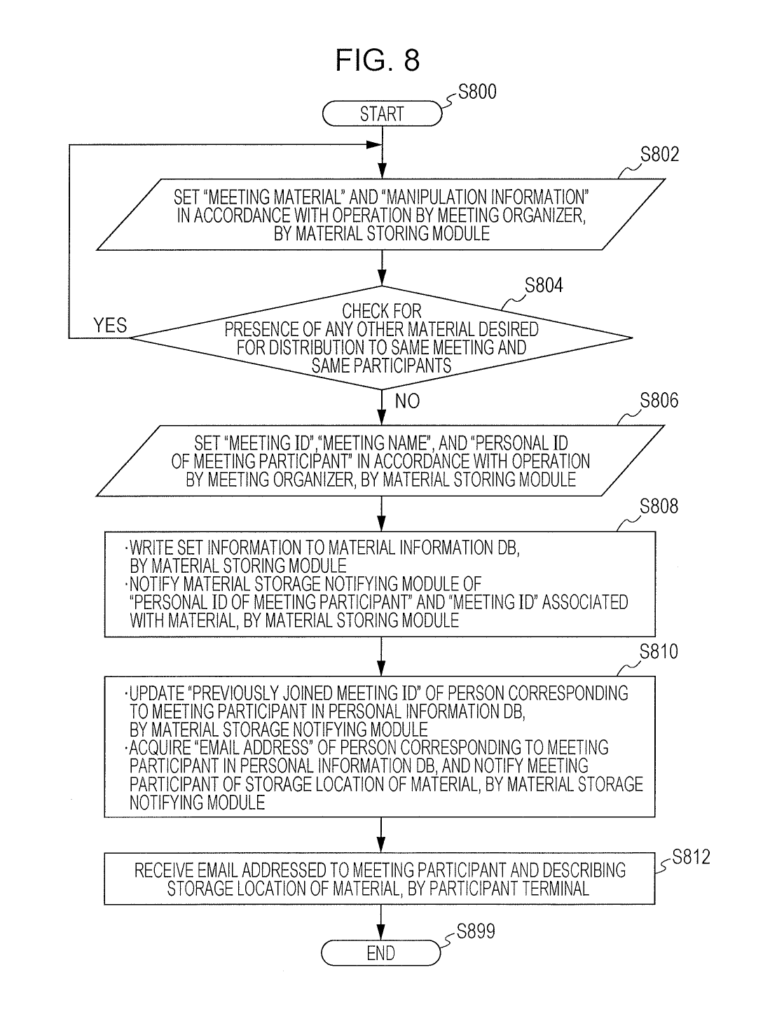

FIG. 8 is a flowchart illustrating an example of processing according to the first exemplary embodiment.

In step S802, the material storing module 110 sets “meeting material” and “manipulation information” in accordance with operation by the meeting organizer.

In step S804, it is checked whether there is any other material desired for distribution to the same meeting and the same participants. The processing returns to step S802 if there is any such material, and proceeds to step S806 if there is no such material.

In step S806, the material storing module 110 sets “meeting ID”, “meeting name”, and “personal ID of meeting participant” in accordance with operation by the meeting organizer.

In step S808, the material storing module 110 writes the pieces of information that have been set to the material information DB 140, and notifies the material storage notifying module 120 of “personal ID of meeting participant” and “meeting ID” associated with the material.

In step S810, the material storage notifying module 120 updates “previously joined meeting ID” of a person corresponding to a meeting participant in the personal information DB 150, acquires “email address” of a person corresponding to a meeting participant in the personal information DB 150, and notifies the meeting participant of the storage location of the material.

In step S812, an email addressed to the meeting participant and describing the storage location of the material is received by the participant terminal 192.

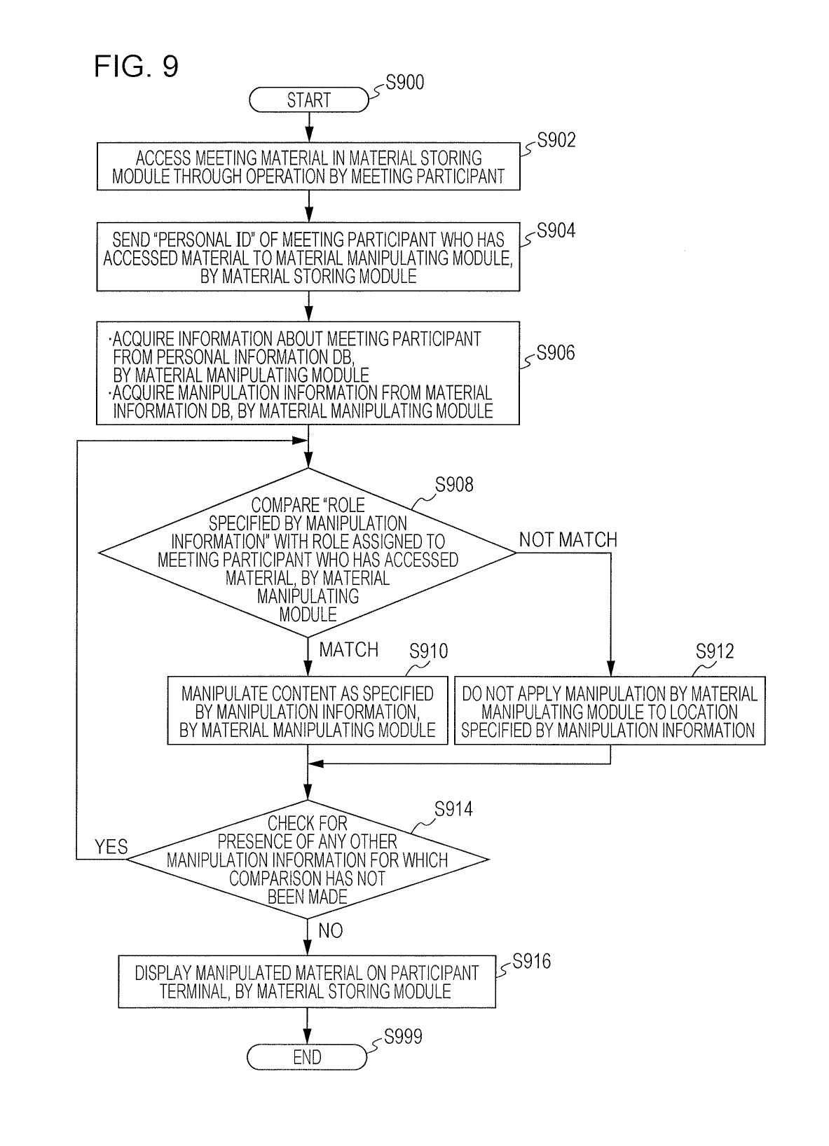

FIG. 9 is a flowchart illustrating an example of processing according to the first exemplary embodiment.

In step S902, a meeting material in the material storing module 110 is accessed through operation by a meeting participant.

In step S904, the material storing module 110 sends “personal ID” of the meeting participant who has accessed the material to the material manipulating module 130.

In step S906, the material manipulating module 130 acquires information about the meeting participant from the personal information DB 150, and acquires manipulation information from the material information DB 140.

In step S908, the material manipulating module 130 compares a “role specified by manipulation information” with the role assigned to the meeting participant who has accessed the material. If the two roles match, the processing proceeds to step S910, and if the two roles do not match, the processing proceeds to step S912.

In step S910, the material manipulating module 130 manipulates content as specified by the manipulation information.

In step S912, the material manipulating module 130 does not apply manipulation to the location specified by the manipulation information.

In step S914, it is checked whether there is any other manipulation information for which the above comparison has not been made. The processing returns to step S908 if there is such manipulation information, and proceeds to step S916 if there is no such manipulation information.

In step S916, the material storing module 110 displays the material that has been manipulated, on the participant terminal 192.

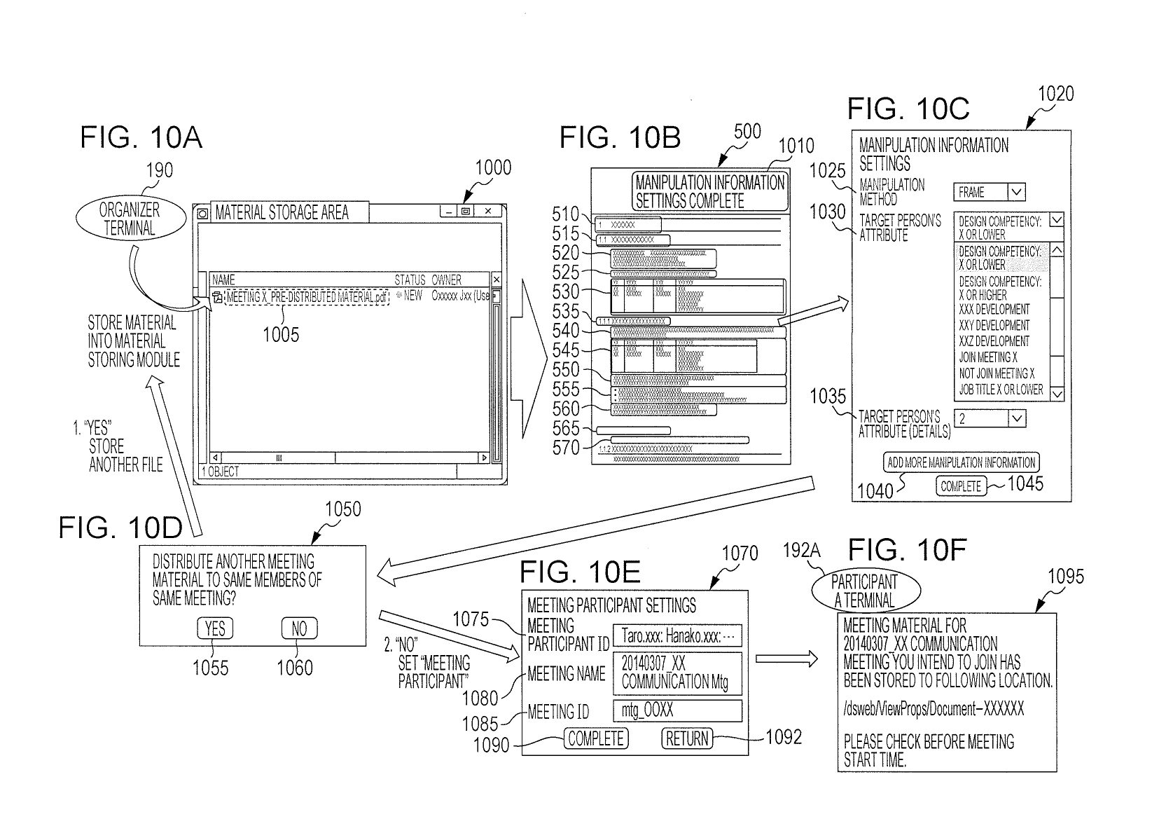

FIGS. 10A to 10F each illustrate an example of processing according to the first exemplary embodiment. In the example illustrated in FIG. 10A, in accordance with operation by the meeting organizer, the organizer terminal 190 displays a material storage area 1000. Then, a document 1005, which is a meeting material, is copied (or moved) into the material storage area 1000. The meeting material is thus stored into the material storing module 110.

Once the meeting material is stored, the stored meeting material (document) is opened, and displayed on the organizer terminal 190 in such a way that allows selection of each individual piece of content. That is, the document 1005 is decomposed into individual pieces of content, and displayed in the manner of the document 500 illustrated in FIG. 10B. The document 500 has a Manipulation Information Settings Complete button 1010, the content 510, the content 515, the content 520, the content 525, the content 530, the content 535, the content 540, the content 545, the content 550, the content 555, the content 560, the content 565, and the content 570. A dialog is displayed when content is selected. For example, when the content 545 is selected through operation by the meeting organizer, a manipulation information settings area 1020 illustrated in FIG. 10C is displayed on the organizer terminal 190.

In the example of FIG. 10C, the manipulation information settings area 1020 has a manipulation method setting field 1025, a target person's attribute setting field 1030, a target person's attribute (details) setting field 1035, an Add button 1040, and a Complete button 1045. The manipulation method setting field 1025 corresponds to the manipulation method table 600 illustrated in FIG. 6. The target person's attribute setting field 1030 corresponds to the target person's attribute table 700 illustrated in FIG. 7A. The target person's attribute (details) setting field 1035 corresponds to each of the target person's attribute (details) (corresponding to XX) table 700X to the target person's attribute (details) (corresponding to α) table 700α illustrated in FIGS. 7B to 7E. The target person's attribute (details) setting field 1035 illustrated in FIG. 10C is used to select what is indicated as “X” in the target person's attribute setting field 1030 (the target person's attribute (details) (corresponding to XX) table 700X). When the Add button 1040 is selected, the processing returns to the display of the document 500 illustrated in FIG. 10B, and content is selected. When the Complete button 1045 is selected, a dialog is displayed. For example, the processing proceeds to FIG. 10D.

In the example of FIG. 10D, a dialog area 1050 is displayed on the organizer terminal 190. Within the dialog area 1050, for example, the following message is displayed: “Distribute another meeting material to the same members (participants) of the same meeting?”, and a Yes button 1055 and a No button 1060 are displayed. If the Yes button 1055 is selected, the processing returns to FIG. 10A. If the No button 1060 is selected, the processing proceeds to FIG. 10E.

In the example of FIG. 10E, a meeting participant settings area 1070 is displayed on the organizer terminal 190. The meeting participant settings area 1070 has a meeting participant ID field 1075, a meeting name field 1080, a meeting ID field 1085, a Complete button 1090, and a Return button 1092. When each field is entered, and the Complete button 1090 is selected, an email is transmitted to each participant of the meeting, and the processing proceeds to FIG. 10F.

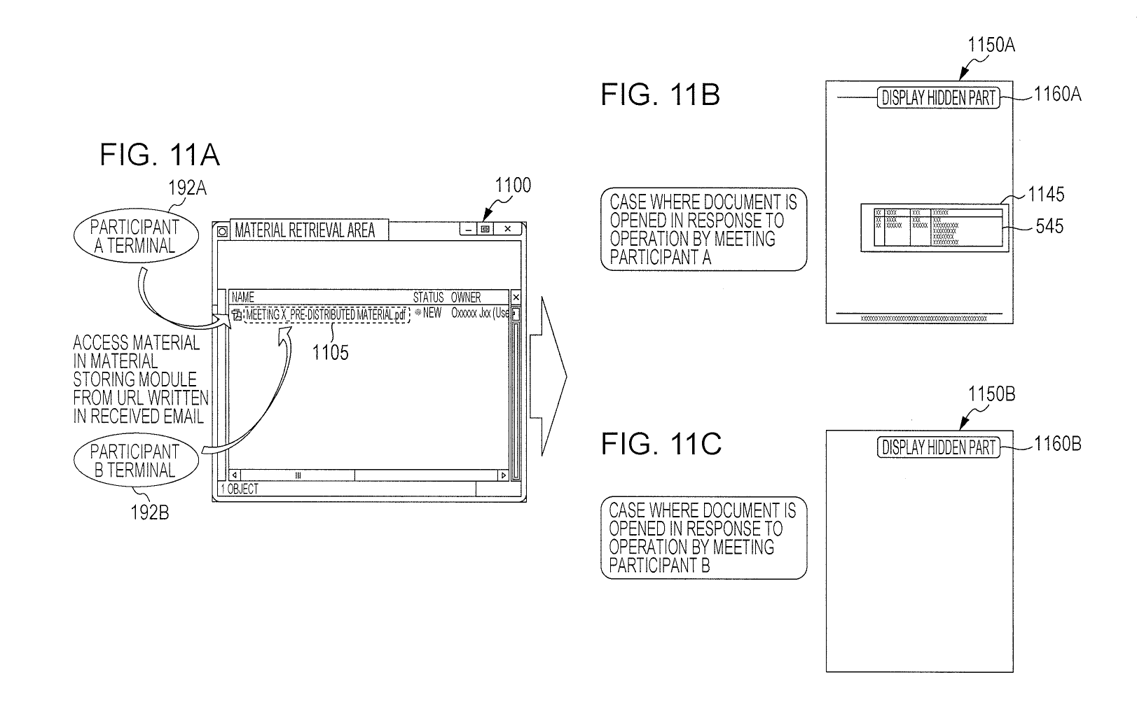

In FIG. 10F, Participant A, who is a participant, receives the email. As a result, an email 1095 is displayed on the Participant A terminal 192A. The storage location of the meeting material is written in the email 1095. When Participant A accesses the storage location, the processing proceeds to FIG. 11A.

FIGS. 11A to 11C each illustrate an example of processing according to the first exemplary embodiment.

In FIG. 11A, on the Participant A terminal 192A, a meeting material in the material storing module 110 is accessed by using a URL written in the received email. A material retrieval area 1100 is displayed on the Participant A terminal 192A. A document 1105 is displayed in the material retrieval area 1100. Likewise, an email also arrives at Participant B, the material retrieval area 1100 is also displayed on the Participant B terminal 192B, and the document 1105 is displayed in the material retrieval area 1100. At this time, it is assumed that the “BB competency” of Participant A is “1”, and the “BB competency” of Participant B is “3.”

A document 1150A in FIG. 11B represents a case where the document 1105 is displayed in response to operation by Meeting Participant A. Within the document 1150A, the content 545 is displayed, and a frame 1145 is displayed so as to enclose the content 545. Further, a Display Hidden Part button 1160A is displayed.

When the Display Hidden Part button 1160A is selected, content other than the content 545 (such as the content 510 and the content 515 illustrated in FIG. 5) is also displayed within the document 1150A. In this case, manipulation information is set so that for a person (participant) with “BB competency: 2 or lower”, the frame 1145 used for manipulation is drawn around the content 545 that is a “table”, and other pieces of content are hidden. Since the “BB competency” of Participant A is “1”, this manipulation information is applied.

A document 1150B in FIG. 11C represents a case where the document 1105 is displayed in response to operation by Meeting Participant B. Only a Display Hidden Part button 1160B is displayed within the document 1150B. In this case, manipulation information is set so that for a person (participant) with “BB competency: 3 or higher”, content on this page is not displayed. Since the “BB competency” of Participant B is “3”, this manipulation information is applied.

The above is an example of manipulation of one page of a meeting material, and similar manipulation may be performed for all pages.

### Second Exemplary Embodiment

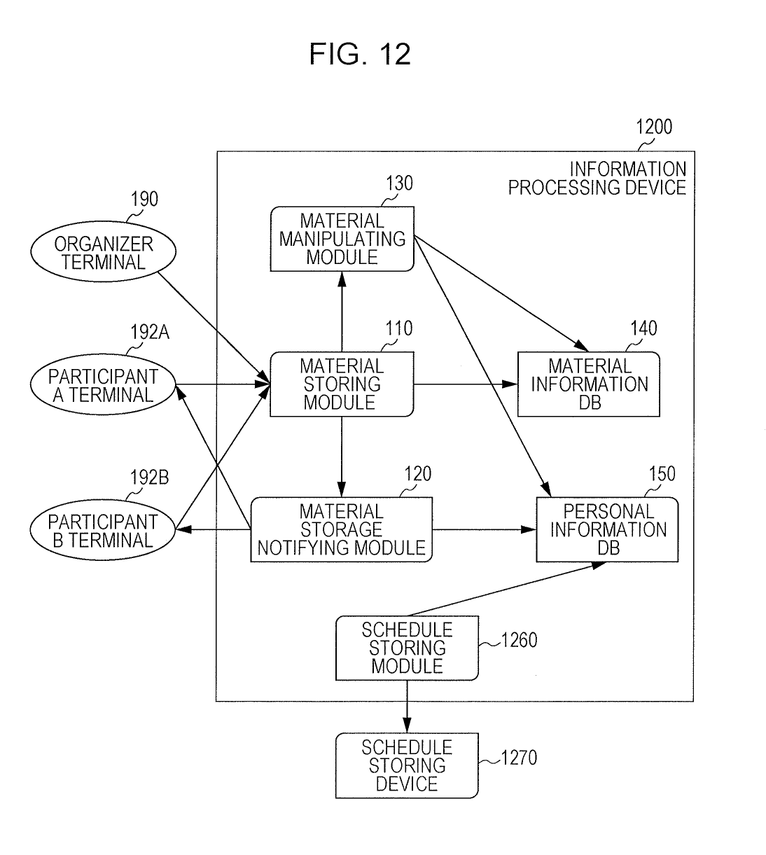

FIG. 12 is a conceptual module diagram of an example of configuration according to a second exemplary embodiment.

An information processing device 1200 has the material storing module 110, the material storage notifying module 120, the material manipulating module 130, the material information DB 140, the personal information DB 150, and a schedule acquiring module 1260. Portions that are similar to those of the first exemplary embodiment are denoted by the same reference symbols, and any repetitive description of these portions is omitted herein (the same applies hereinafter). For example, the information processing device 1200 changes the amount of content to be displayed based on whether there is much time remaining to view a meeting material or not.

The personal information DB 150 is connected to the material storage notifying module 120, the material manipulating module 130, and the schedule acquiring module 1260.

The schedule acquiring module 1260 is connected to the personal information DB 150 and a schedule storing device 1270. The schedule acquiring module 1260 acquires the schedule of the meeting participant of interest until the meeting.

Specifically, in order to set manipulation information by taking into consideration how much time is available for a meeting participant to view a material, the schedule acquiring module 1260 has a mechanism that makes it possible to acquire information on how much free (i.e., unscheduled) time is available for the meeting participant before the meeting start time. For example, this mechanism is used to perform a manipulation such as reducing, as the meeting start time approaches, the amount of information in the meeting material which is to be displayed.

Specifically, the material storage notifying module 120 has a mechanism for acquiring a schedule for each individual person from the schedule storing device 1270 located outside the information processing device 1200.

Further, the schedule acquiring module 1260 has a mechanism for storing the acquired schedule into the personal information DB 150.

The schedule storing device 1270 is connected to the schedule acquiring module 1260 of the information processing device 1200. The schedule storing device 1270 is a scheduler used daily by a potential meeting participant. The schedule in the scheduler is written by the potential participant himself/herself, or by a person other than the potential participant himself/herself (for example, the potential participant's superior, or the meeting organizer).

In addition to the functions according to the first exemplary embodiment mentioned above, the material manipulating module 130 uses the schedule of the meeting participant of interest to compute the duration of time before the meeting (specifically, the period of time from the current time to the start of the meeting). Then, the material manipulating module 130 manipulates the meeting material by applying the computed time to a rule. The rule used at this time may provide that the meeting material be manipulated in accordance with the amount of time. Further, this rule may include manipulating the meeting material in accordance with importance. In this case, the manipulation method may be determined as follows. First, a table that provides a correspondence between amount of time and importance is prepared in advance. Then, the table is used to extract an importance from a given amount of time, and the importance is applied to the rule to determine the manipulation method.

Since a manipulation process by the material manipulating module 130 is performed as appropriate at the time of viewing, the manipulation is performed when a meeting material is viewed.

Specifically, the material manipulating module 130 has a mechanism for displaying, to a person who has accessed a meeting material, a meeting material that has been manipulated into a form that takes “personal experience” and “schedule until the meeting” into account.

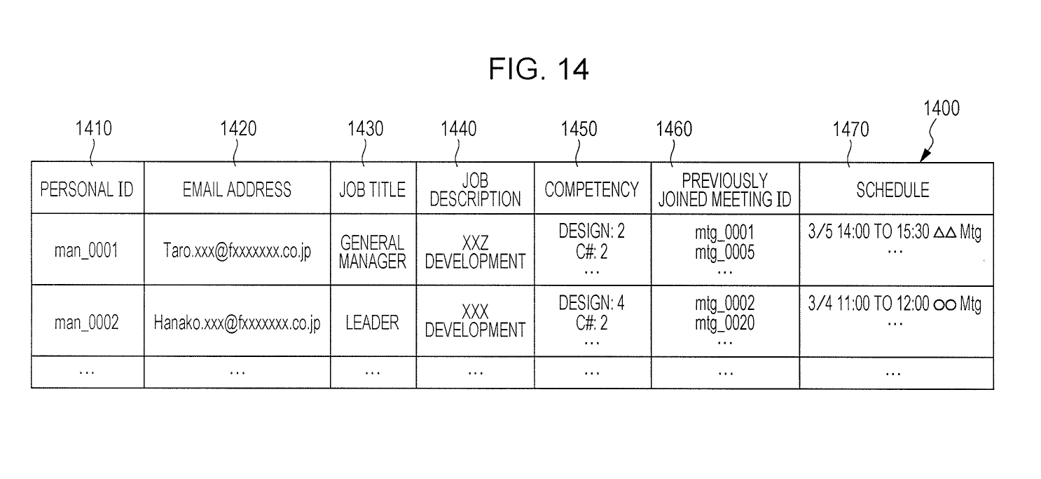

The personal information DB 150 stores, for example, a personal information table 1400. FIG. 14 illustrates an example of the data structure of the personal information table 1400. The personal information table 1400 has a personal ID field 1410, an email address field 1420, a job title field 1430, a job description field 1440, a competency field 1450, a previously joined meeting ID field 1460, and a schedule field 1470. The personal information table 1400 is the same as the personal information table 400 illustrated in FIG. 4, with the addition of the schedule field 1470. The schedule field 1470 stores schedule information about a potential participant indicated by the personal ID of interest. That is, the schedule field 1470 stores schedule information acquired by the schedule acquiring module 1260 from the schedule storing device 1270.

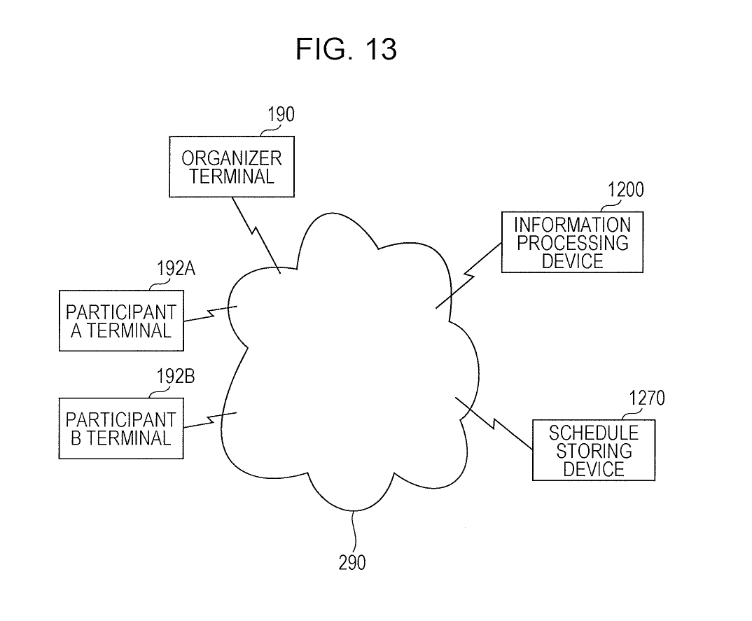

FIG. 13 illustrates an example of system configuration in a case where the second exemplary embodiment is implemented.

The information processing device 1200, the organizer terminal 190, the Participant A terminal 192A, the Participant B terminal 192B, and the schedule storing device 1270 are connected to each other via the communication line 290. This system configuration in FIG. 13 is the same as the system configuration illustrated in FIG. 2, with the addition of the schedule storing device 1270.

The process executed when the meeting organizer sets information for a material according to the second exemplary embodiment is similar to that of the flowchart illustrated in FIG. 8, except for that in step S802, “importance” is further set as manipulation information by the material storing module 110 in accordance with operation by the meeting organizer.

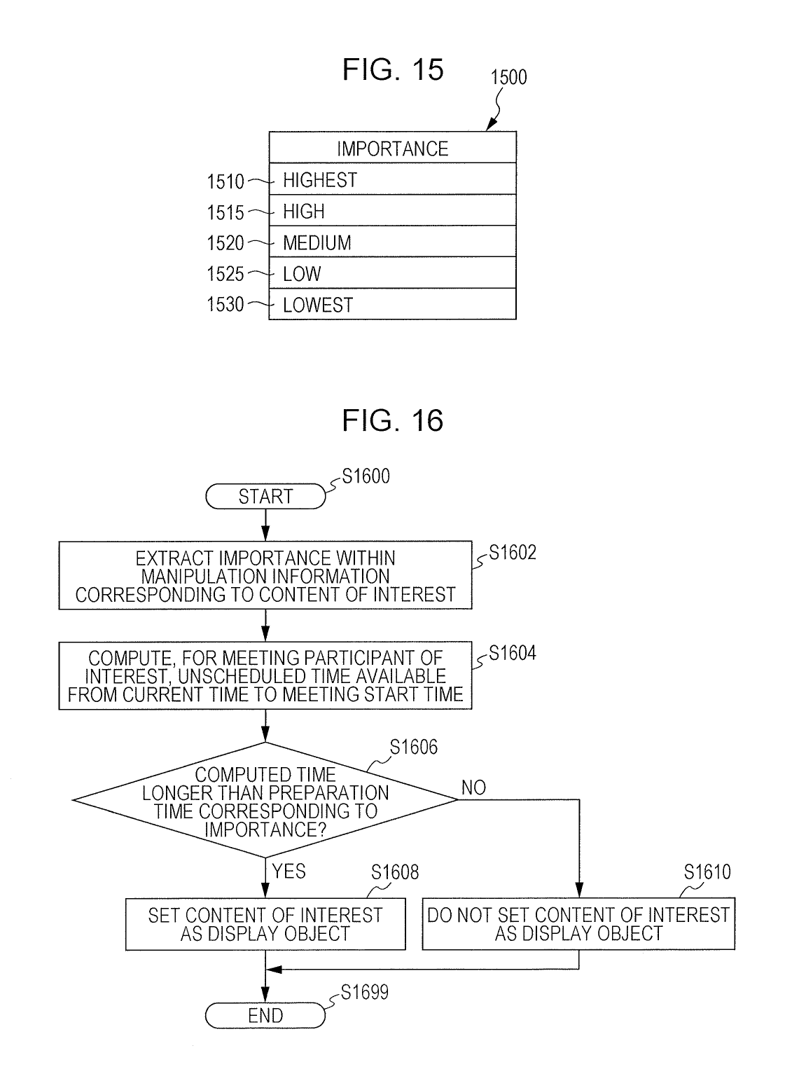

FIG. 15 illustrates an example of the data structure of an importance table 1500. The importance table 1500, which stores a predetermined importance for each individual piece of content, has the following pieces of information: Highest 1510, High 1515, Medium 1520, Low 1525, and Lowest 1530. For example, the importance table 1500 is displayed on the organizer terminal 190, and in accordance with operation of the organizer terminal 190 by the meeting organizer, an importance is selected from the importance table 1500 to specify a manipulation method for a manipulation object.

FIG. 16 is a flowchart illustrating an example of processing according to the second exemplary embodiment.

FIG. 16 is a flowchart illustrating an example of how processing is performed in accordance with importance in step S910 illustrated in FIG. 9.

In step S1602, an importance within manipulation information corresponding to the content of interest is extracted.

In step S1604, for the meeting participant of interest, unscheduled time available from the current time to the meeting start time is computed.

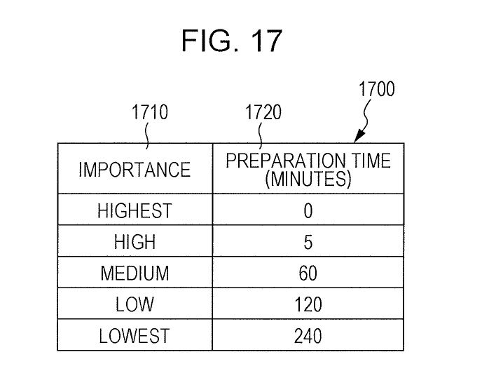

In step S1606, it is determined whether the computed time is longer than a preparation time corresponding to the importance. If the computed time is longer than the preparation time, the processing proceeds to step S1608. Otherwise, the processing proceeds to step S1610. For this determination, for example, an importance/preparation time correspondence table 1700 is used. FIG. 17 illustrates an example of the data structure of the importance/preparation time correspondence table 1700. The importance/preparation time correspondence table 1700 has an importance field 1710, and a preparation time field 1720. The importance field 1710 stores an importance. The preparation time field 1720 stores a preparation time corresponding to the importance.

In step S1608, the content of interest is set as a display object.

In step S1610, the content of interest is not set as a display object.

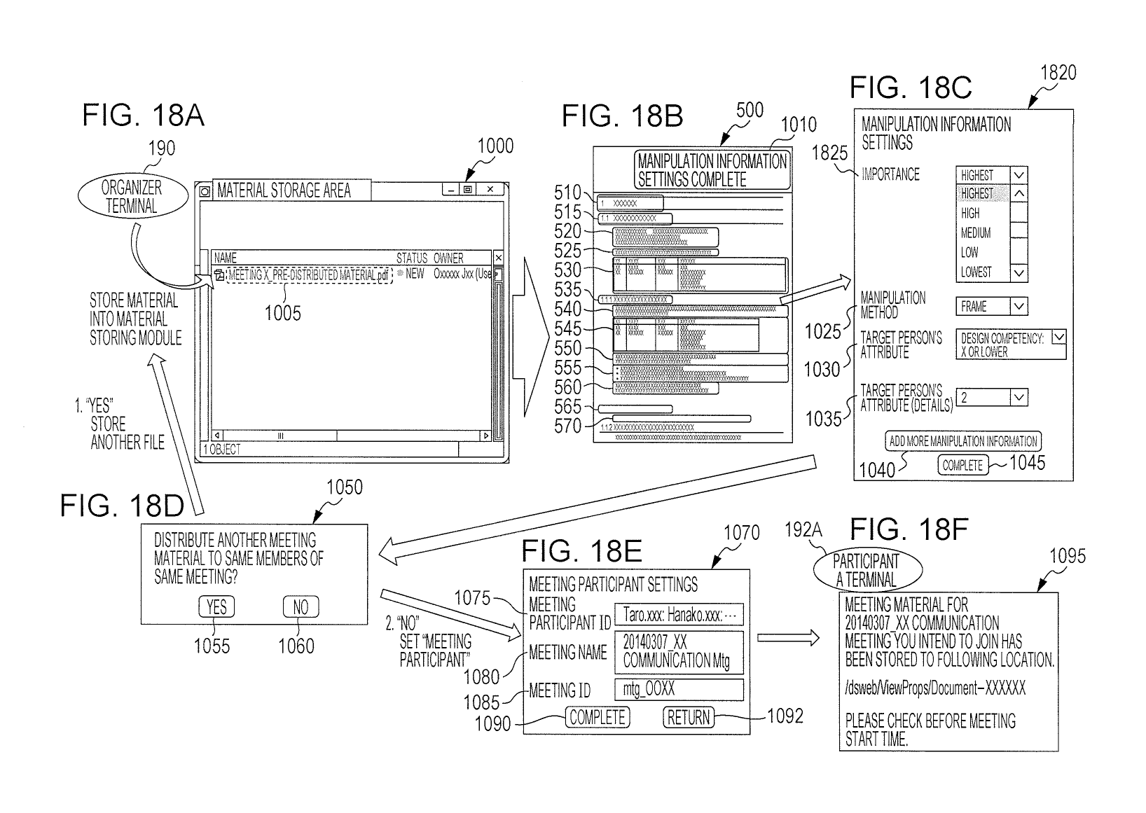

FIGS. 18A to 18F each illustrate an example of processing according to the second exemplary embodiment. FIGS. 18A to 18F correspond to the example of FIGS. 10A to 10F according to the first exemplary embodiment. FIGS. 18A, 18B, 18D, 18E, and 18F are equivalent to FIGS. 10A, 10B, 10D, 10E, and 10F, respectively.

In the example of FIG. 18C, a manipulation information settings area 1820 has an importance setting field 1825, the manipulation method setting field 1025, the target person's attribute setting field 1030, the target person's attribute (details) setting field 1035, the Add button 1040, and the Complete button 1045. The importance setting field 1825 corresponds to the importance/preparation time correspondence table 1700 illustrated in FIG. 17. The manipulation method setting field 1025 corresponds to the manipulation method table 600 illustrated in FIG. 6. The target person's attribute setting field 1030 corresponds to the target person's attribute table 700 illustrated in FIG. 7A. The target person's attribute (details) setting field 1035 corresponds to each of the target person's attribute (details) (corresponding to XX) table 700X to the target person's attribute (details) (corresponding to α) table 700α illustrated in FIGS. 7B to 7E. When the Add button 1040 is selected, the processing returns to display of the document 500 illustrated in FIG. 18B to select content. When the Complete button 1045 is selected, a dialog is displayed. For example, the processing proceeds to FIG. 18D.

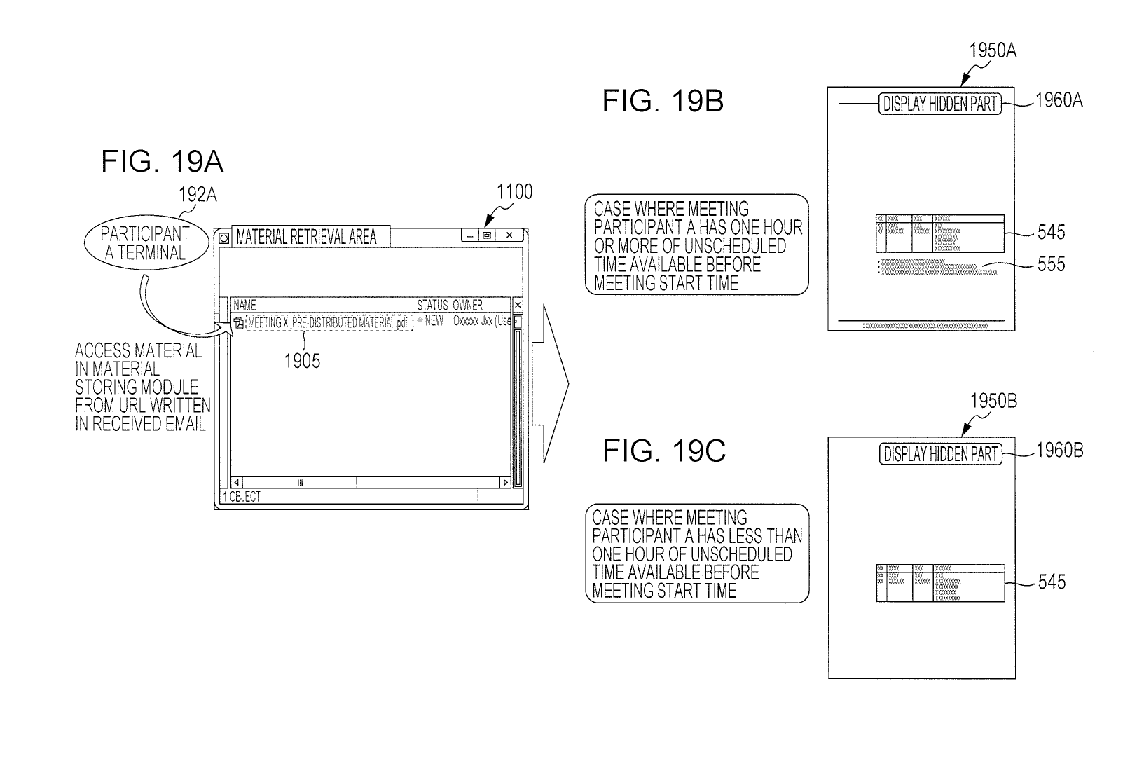

FIGS. 19A to 19C each illustrate an example of processing according to the second exemplary embodiment. FIGS. 19A to 19C correspond to the example of FIGS. 11A to 11C according to the first exemplary embodiment. FIG. 19A is equivalent to FIG. 11A. This example only illustrates an example of access by Participant A. This is because this example is intended to illustrate how the information displayed varies with the time available before the meeting start time. Of course, information is displayed in a similar manner when access is made by Participant B. A document 1905 is displayed in the material retrieval area 1100. At this time, it is assumed that manipulation information is set so that the importance assigned to the content 545 that is a “table” is “highest”, and the importance assigned to the content 555 that is an “itemized list” is “medium” That is, by using the importance/preparation time correspondence table 1700, manipulation information is set so that the content 545 is displayed even if unscheduled time available before the meeting start time is 0 minute, and the content 555 is displayed if unscheduled time available before the meeting start time is greater than or equal to 60 minutes (not displayed if available unscheduled time is less than 60 minutes).

A document 1950A in FIG. 19B represents a case where the document 1905 is displayed in response to operation by Meeting Participant A. This illustrates an example of display for a case where there is one hour or more of unscheduled time for Meeting Participant A before the meeting start time. Therefore, the content 545 and the content 555 are displayed within the document 1950A. Further, a Display Hidden Part button 1960A is displayed. When the Display Hidden Part button 1960A is selected, content other than the content 545 and the content 555 (such as the content 510 and the content 515 illustrated in FIG. 5) is also displayed within the document 1950A.

A document 1950B in FIG. 19C represents a case where the document 1905 is displayed in response to operation by Meeting Participant A. This illustrates an example of display for a case where there is less than one hour of unscheduled time for Meeting Participant A before the meeting start time. Therefore, only the content 545 is displayed within the document 1950B. Further, a Display Hidden Part button 1960B is displayed. When the Display Hidden Part button 1960B is selected, content other than the content 545 (such as the content 510 and the content 515 illustrated in FIG. 5) is also displayed within the document 1950B.

The above is an example of manipulation of one page of a meeting material, and similar manipulation may be performed for all pages.

### Third Exemplary Embodiment

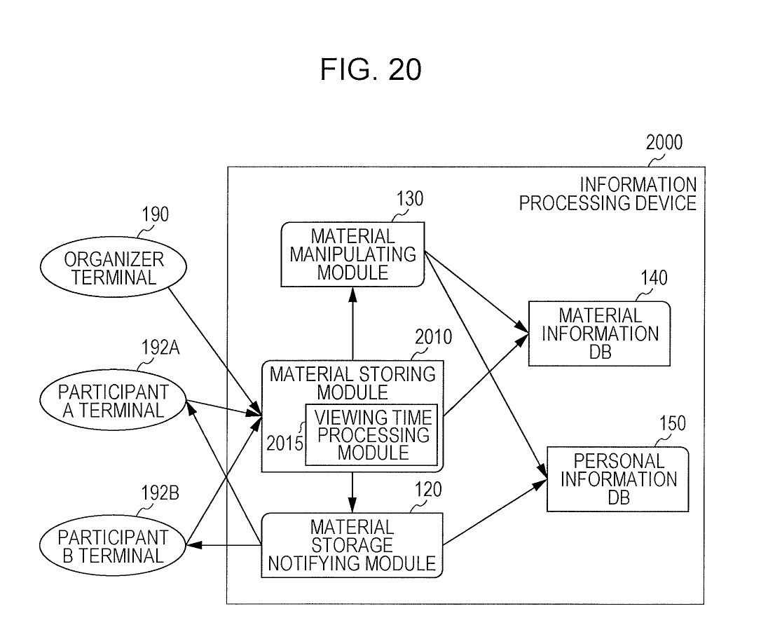

FIG. 20 is a conceptual module diagram of an example of configuration according to a third exemplary embodiment.

An information processing device 2000 has a material storing module 2010, the material storage notifying module 120, the material manipulating module 130, the material information DB 140, and the personal information DB 150. That is, the material storing module 110 according to the first exemplary embodiment is replaced with the material storing module 2010. The material storing module 2010 has a viewing time processing module 2015. The material storing module 2010 has a function equivalent to the material storing module 110 according to the first exemplary embodiment.

The material storing module 2010 is connected to the material storage notifying module 120, the material manipulating module 130, the material information DB 140, the organizer terminal 190, the Participant A terminal 192A, and the Participant B terminal 192B.

The viewing time processing module 2015 displays a viewing history of another participant with respect to a meeting material that has been manipulated by the material manipulating module 130, to the participant terminal 192 that has accessed the meeting material. Specifically, with respect to a meeting material manipulated for Participant A, a history (to be also referred to as “log” hereinafter) of the Participant A's viewing of the meeting material is acquired, and the acquired history is presented to Participant B who has accessed the meeting material.

Further, the viewing time processing module 2015 has a mechanism that makes it possible to check which content in a meeting material has been viewed by a meeting participant. In order to allow the meeting organizer to proceed with the meeting in a manner that takes the viewing status into consideration, for example, the meeting organizer may be made to check the above-mentioned log immediately before the meeting starts.

That is, the viewing time processing module 2015 has a mechanism that makes it possible to check the display state of information as viewed by another person (including, for example, a state in which a hidden part is caused to be displayed again). Further, the viewing time processing module 2015 has a mechanism for recording, for each page, the time for which the page has been viewed by a person viewing the material.

Further, the history of another person which may be viewed may be limited to the history of a participant having attributes equivalent to those of the accessing participant himself/herself.

Processing such as setting of manipulation information is performed in the same manner as in the above exemplary embodiments.

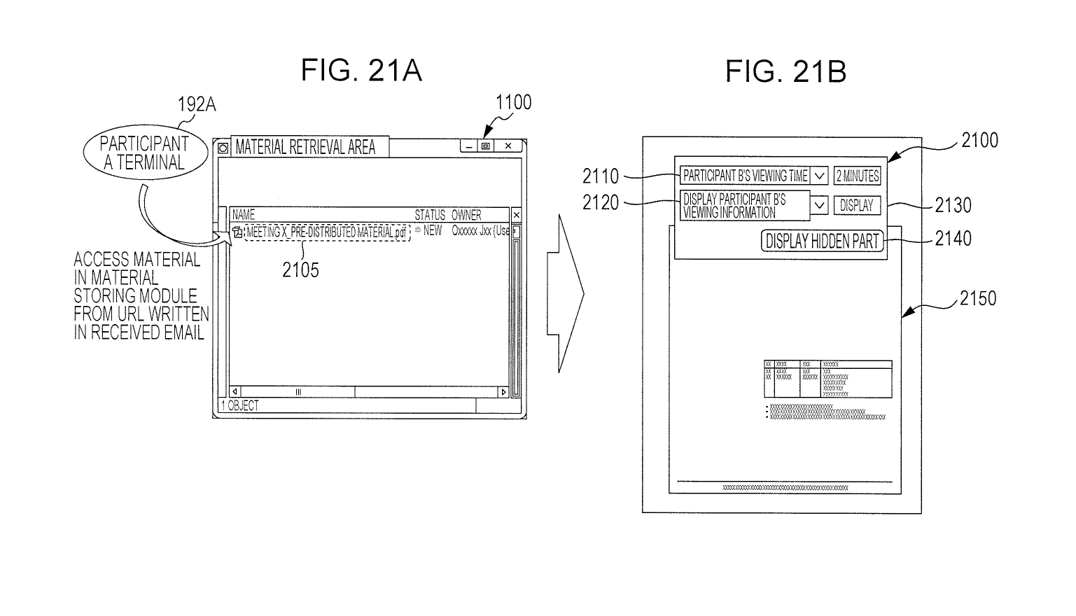

FIGS. 21A and 21B each illustrate an example of processing according to the third exemplary embodiment. FIGS. 21A and 21B correspond to the example of FIGS. 11A to 11C according to the first exemplary embodiment. FIG. 21A is equivalent to FIG. 11A. A document 2105 is displayed in a material retrieval area. This example only illustrates an example of access by Participant A. Of course, information is displayed in a similar manner when access is made by Participant B.

A document 2150 in FIG. 21B represents a case where the document 2105 is displayed in response to operation by Meeting Participant A. At this time, an other's viewing settings area 2100 is displayed in addition to the document 2105. Within the other's viewing settings area 2100, an other's viewing time setting field 2110, an other's viewing information setting field 2120, a Display button 2130, and a Display Hidden Part button 2140 are displayed.

In the other's viewing time setting field 2110, another participant (a participant other than Participant A, for example, Participant B) is specified, and the amount of time the document 2105 has been viewed by the other participant is displayed. That is, the other's viewing time setting field 2110 is used to check the viewing time per page of another participant.

In the other's viewing information setting field 2120, first, another participant is specified. Then, when the Display button 2130 is selected, information displayed when the document 2105 is viewed by the other participant specified in the other's viewing information setting field 2120 is displayed within the document 2150. That is, the content that has been displayed by the other participant is displayed.

When the Display Hidden Part button 2140 is selected, content (content set as hidden content) other than the content displayed upon selecting the Display button 2130 is displayed.

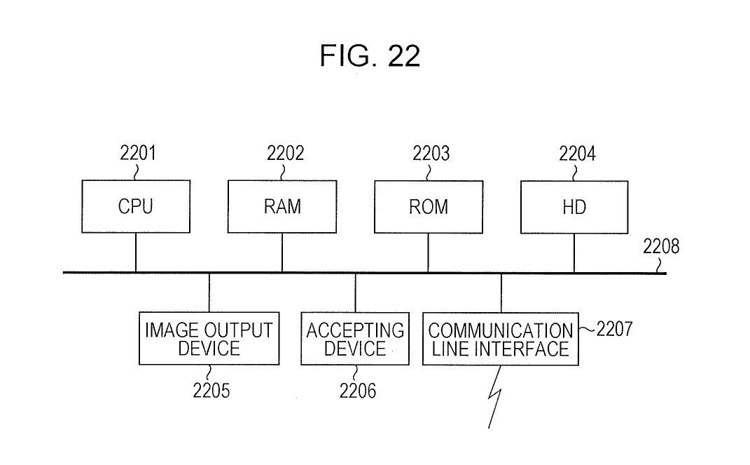

The hardware configuration of a computer on which the program according to the exemplary embodiments is executed is that of a general computer as illustrated in FIG. 22, specifically, a computer or the like that may serve as a personal computer or a server. That is, as a specific example, a CPU 2201 is used as a processing unit (arithmetic unit), and a RAM 2202, a ROM 2203, and a HD 2204 are used as memories. For example, a hard disk or a solid state drive (SSD) may be used as the HD 2204. The computer is made up of: the CPU 2201 that executes a program for implementing modules such as the material storing module 110, the material storage notifying module 120, the material manipulating module 130, the schedule acquiring module 1260, and the material storing module 2010; the RAM 2202 that stores the program and data; the ROM 2203 in which a program for booting the computer, and the like are stored; the HD 2204 that serves as an auxiliary memory (which may be a flash memory or the like); an accepting device 2206 that accepts data on the basis of a user's operation with a keyboard, a mouse, a touch panel, or the like; an image output device 2205 such as a CRT or a liquid crystal display; a communication line interface 2207 for establishing a connection with a communication network, such as a network interface card; and a bus 2208 that interconnects the above-mentioned components to exchange data. Multiple such computers may be connected to each another via a network.

For features based on a computer program in the foregoing exemplary embodiments, a system having the above-mentioned hardware configuration is caused to read the computer program as software, and as the software cooperates with hardware resources, the foregoing exemplary embodiments are implemented.

The hardware configuration depicted in FIG. 22 is only illustrative. The exemplary embodiments are not limited to the configuration illustrated in FIG. 22 as long as the modules described in the exemplary embodiments may be executed. For example, some modules may be implemented by dedicated hardware (such as an application-specific integrated circuit (ASIC)), and some modules may be provided within an external system and may be connected via a communication line. Further, multiple systems configured as illustrated in FIG. 22 may be connected to each another by a communication line so as to operate in cooperation with each other. Further, other than personal computers, the above configuration may be incorporated in, in particular, information home appliances, copiers, facsimiles, scanners, printers, multifunction machines (image processing devices having two or more of, for example, scanner, printer, copier, and facsimile functions).

In the foregoing exemplary embodiments, words or phrases that mean “greater (higher) than or equal to”, “less (lower) than or equal to”, “greater (higher) than”, and “less (lower) than”, or their equivalents used when making comparisons with predetermined values may be read as “greater (higher) than”, “less (lower) than”, “greater (higher) than or equal to”, and “less (lower) than or equal to”, respectively, as long as consistency is maintained in the respective combinations.

Further, the second exemplary embodiment and the third exemplary embodiment may be combined. That is, the material storing module 110 provided within the information processing device 1200 illustrated in FIG. 12 may be replaced with the material storing module 2010 provided within the information processing device 2000 illustrated in FIG. 20.

A program described herein may be provided in the form of being stored in a recording medium, or the program may be provided via a communication unit. In that case, for example, the above-mentioned program may be understood as an invention relating to a “computer readable recording medium recording a program.”

The “computer readable recording medium recording a program” refers to a computer readable recording medium on which a program is recorded and which is used for purposes such as installing, executing, and distributing the program.

Examples of the recording medium include digital versatile discs (DVDs), such as “DVD-R, DVD-RW, DVD-RAM, and the like”, which are standards developed by the DVD Forum, and “DVD+R, DVD+RW, and the like”, which are standards developed by the DVD Forum, compact discs (CDs) such as read-only memory (CD-ROM), CD-Recordable (CD-R), and CD-Rewritable (CD-RW) discs, Blu-ray (registered trademark) discs, magneto-optical disks (MOs), flexible disks (FDs), magnetic tapes, hard disks, read-only memories (ROMs), electrically erasable programmable read-only memories (EEPROMs (registered trademark)), flash memories, random access memories (RAMs), and Secure Digital (SD) memory cards.

The above-mentioned program or a portion thereof may be recorded on the above-mentioned recording medium for purposes such as saving and distribution. Alternatively, the program may be transmitted via a transmission medium such as a wired network or a wireless communication network which is used for a local area network (LAN), a metropolitan area network (MAN), a wide area network (WAN), the Internet, an intranet, an extranet, and the like, or a combination thereof, or may be carried on a carrier wave.

Further, the program mentioned above may be part of another program, or may be recorded on a recording medium together with a different program. Alternatively, the program may be recorded separately on multiple recording media. Furthermore, the program may be recorded in any form, such as compressed or encrypted, as long as the program may be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an accepting unit that accepts a meeting material that is a material distributed to a participant of a meeting, information indicating the participant of the meeting, and a rule for manipulating the meeting material based on an attribute of the participant;
an extracting unit that extracts the attribute of the participant; and
a manipulating unit that manipulates the meeting material, by applying the attribute of the participant to the rule.

2. The information processing device according to claim 1, further comprising:
an acquiring unit that acquires a schedule of the participant; and
a computing unit that computes a duration of time before the meeting by using the acquired schedule of the participant,
wherein the rule further indicates how to manipulate the meeting material based on the duration of time before the meeting, and wherein
the manipulating unit manipulates the meeting material by applying the duration of time computed by the computing unit to the rule.

3. The information processing device according to claim 1, further comprising a display that displays a viewing history of another participant with respect to the meeting material manipulated by the manipulating unit.

4. The information processing device according to claim 2, further comprising a display that displays a viewing history of another participant with respect to the meeting material manipulated by the manipulating unit.

5. A non-transitory computer readable program storing a program causing a computer to execute a process for processing information, the process comprising:
accepting a meeting material that is a material distributed to a participant of a meeting, information indicating the participant of the meeting, and a rule for manipulating the meeting material based on an attribute of the participant;
extracting the attribute of the participant; and
manipulating the meeting material, by applying the attribute of the participant to the rule.

6. An information processing method comprising:
accepting a meeting material that is a material distributed to a participant of a meeting, information indicating the participant of the meeting, and a rule for manipulating the meeting material based on an attribute of the participant;
extracting the attribute of the participant; and
manipulating the meeting material, by applying the attribute of the participant to the rule.
